(19) United States
(12) Patent Application Publication
(10) Pub. No.: US 2015/0276984 A1
(43) Pub. Date: Oct. 1, 2015

(54) OPTICAL MATERIAL, OPTICAL ELEMENT AND HYBRID OPTICAL ELEMENT

(71) Applicant: Panasonic Intellectual Property Management Co., Ltd., Osaka (JP)

(72) Inventors: Takanori YOGO, Kyoto (JP); Shinya HASEGAWA, Kyoto (JP)

(21) Appl. No.: 14/668,632

(22) Filed: Mar. 25, 2015

(30) Foreign Application Priority Data
Mar. 27, 2014 (JP) 2014-066330
Mar. 4, 2015 (JP) 2015-042564

(51) Int. Cl. G02B 1/02; G02B 1/04

(52) U.S. Cl. CPC G02B 1/02; G02B 1/04

(57) ABSTRACT

An optical material is composed of a resin material and inorganic fine particles dispersed in the resin material. The inorganic fine particles contain at least gallium phosphate fine particles. An optical element is formed of the above-described optical material. A hybrid optical element includes a first optical element and a second optical element disposed on an optical surface of the first optical element. The second optical element is the above-described optical element.

### CROSS-REFERENCE TO RELATED APPLICATION

This application is based on application No. 2014-066330 filed in Japan on Mar. 27, 2014 and application No. 2015-042564 filed in Japan on Mar. 4, 2015, the contents of which are hereby incorporated by reference.

### BACKGROUND

1. Field

The present disclosure relates to optical materials, optical elements, and hybrid optical elements.

2. Description of the Related Art

Optical materials in which inorganic fine particles are dispersed in a matrix material such as a resin to increase the range of their optical properties are known (hereinafter, optical materials having such a structure are also referred to as “composite materials”). Techniques for achieving desired optical properties such as an anomalous dispersion property by using such composite materials are known.

Japanese Patent Publication No. 4217032 discloses an optical element obtained by molding a composition which contains fine particles containing Si, and an organic-inorganic composite material constituted of an organic high molecular material containing an amorphous fluororesin and an inorganic component.

### SUMMARY

The present disclosure provides: an optical material whose optical constants can be freely controlled in a wide range, and which has a high refractive index and large positive anomalous dispersion; and an optical element and a hybrid optical element each formed of the optical material.

The novel concepts disclosed herein were achieved in order to solve the foregoing problems in the related art, and herein is disclosed:

an optical material comprising a resin material and inorganic fine particles dispersed in the resin material, the inorganic fine particles containing at least gallium phosphate fine particles.

The novel concepts disclosed herein were achieved in order to solve the foregoing problems in the related art, and herein is disclosed:

an optical element formed of an optical material which comprises a resin material and inorganic fine particles dispersed in the resin material, the inorganic fine particles containing at least gallium phosphate fine particles.

The novel concepts disclosed herein were achieved in order to solve the foregoing problems in the related art, and herein is disclosed:

a hybrid optical element comprising a first optical element and a second optical element disposed on an optical surface of the first optical element, the second optical element being an optical element which is formed of an optical material comprising a resin material and inorganic fine particles dispersed in the resin material, the inorganic fine particles containing at least gallium phosphate fine particles.

The optical material according to the present disclosure is the composite material in which the inorganic fine particles containing at least the gallium phosphate fine particles are dispersed in the resin material allows free control of its optical constants in a wide range, and has a high refractive index and large positive anomalous dispersion.

### BRIEF DESCRIPTION OF THE DRAWINGS

This and other objects and features of the present disclosure will become clear from the following description, taken in conjunction with the exemplary embodiments with reference to the accompanied drawings in which:

FIG. 1 is a schematic diagram showing a composite material according to Embodiment 1;

FIG. 2 is a graph explaining an effective particle diameter of inorganic fine particles;

FIG. 3 is a graph showing the relationship between the refractive index and the Abbe number of each of gallium phosphate and an acrylic resin, according to Embodiment 1;

FIG. 4 is a graph showing the relationship between the partial dispersion ratio and the Abbe number of each of gallium phosphate and the acrylic resin, and a normal dispersion line, according to Embodiment 1;

FIG. 5 is a schematic structural diagram showing a lens according to Embodiment 2, which is an example of an optical element;

FIG. 6 is a schematic structural diagram showing a hybrid lens according to Embodiment 2, which is an example of a hybrid optical element;

FIG. 7 is a schematic diagram explaining an example of a production process of the hybrid lens according to Embodiment 2;

FIG. 8 is a graph showing the relationship between the refractive index and the Abbe number of each of materials according to Examples and Comparative Example; and

FIG. 9 is a graph showing the relationship between the partial dispersion ratio and the Abbe number of each of the materials according to Examples and Comparative Example, and a normal dispersion line.

### DETAILED DESCRIPTION

Hereinafter, embodiments will be described with reference to the drawings as appropriate. However, descriptions more detailed than necessary may be omitted. For example, detailed description of already well known matters or description of substantially identical configurations may be omitted. This is intended to avoid redundancy in the description below, and to facilitate understanding of those skilled in the art.

It should be noted that the applicants provide the attached drawings and the following description so that those skilled in the art can fully understand this disclosure. Therefore, the drawings and description are not intended to limit the subject defined by the claims.

### Embodiment 1

Hereinafter, Embodiment 1 is described with reference to the drawings.

[1. Composite Material]

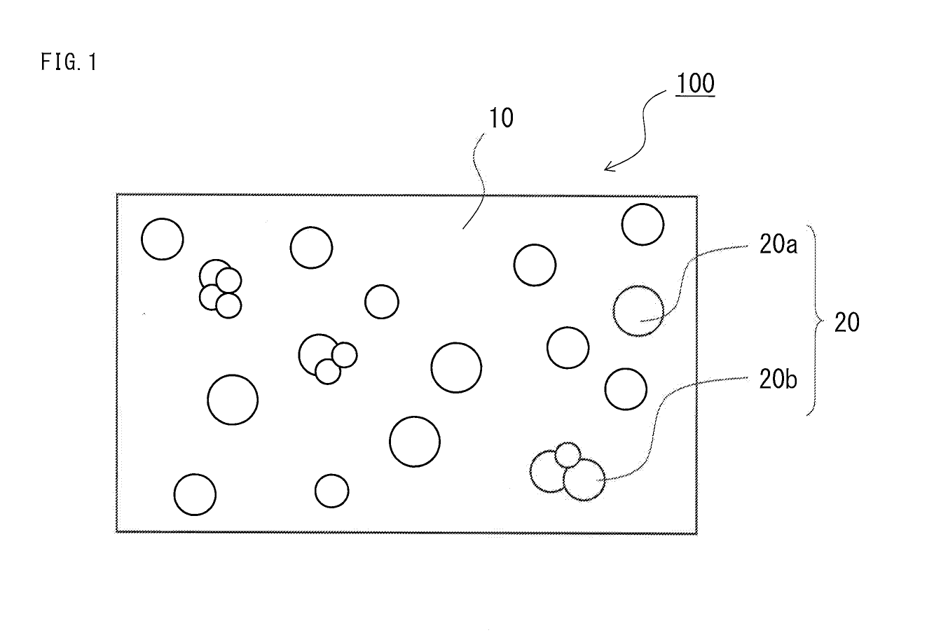

FIG. 1 a schematic diagram showing a composite material 100 according to Embodiment 1. The composite material 100 is an example of an optical material according to the present disclosure, and is composed of a resin material 10 serving as a matrix material, and inorganic fine particles 20 containing at least gallium phosphate fine particles. The inorganic fine particles 20 are dispersed in the resin material 10. A lens as an example of an optical element and a hybrid lens as an example of a hybrid optical element, which are described later, are formed of the composite material 100.

[2. Inorganic Fine Particles]

The inorganic fine particles 20 may be either aggregated particles or non-aggregated particles. Generally, the inorganic fine particles 20 include primary particles 20a and secondary particles 20b which are aggregates of the primary particles 20a. The dispersion state of the inorganic fine particles 20 is not particularly limited because desired effects can be obtained as long as the inorganic fine particles 20 are present in the resin material 10 serving as a matrix material. However, it is beneficial that the inorganic fine particles 20 are uniformly dispersed in the resin material 10. As used herein, “the inorganic fine particles 20 uniformly dispersed in the resin material 10” means that the primary particles 20a and the secondary particles 20b of the inorganic fine particles 20 are substantially uniformly dispersed in the composite material 100 without being localized in any particular region in the composite material 100. It is beneficial that the particles have good dispersion property in order to prevent light transmittance of the optical material from being degraded. For this purpose, it is beneficial that the inorganic fine particles 20 consist of only the primary particles 20a.

The particle diameter of the inorganic fine particles 20 is an essential factor in ensuring the light transmittance of the composite material 100 in which the inorganic fine particles 20 containing at least gallium phosphate fine particles are dispersed in the resin material 10. When the particle diameter of the inorganic fine particles 20 is sufficiently smaller than the wavelength of light, the composite material 100 in which the inorganic fine particles 20 are dispersed in the resin material 10 can be regarded as a homogeneous medium without variations in the refractive index. Therefore, it is beneficial that the particle diameter of the inorganic fine particles 20 is equal to or smaller than the wavelength of visible light. Since visible light has wavelengths ranging from 400 nm to 700 nm, it is beneficial that the maximum particle diameter of the inorganic fine particles 20 is 400 nm or less. It is noted that the maximum particle diameter of the inorganic fine particles 20 can be obtained by taking a scanning electron microscope photograph of the inorganic fine particles 20 and measuring the particle diameter of the largest inorganic fine particle 20 (the secondary particle diameter if the largest particle is a secondary particle).

When the particle diameter of the inorganic fine particles 20 is larger than one fourth of the wavelength of light, the light transmittance of the composite material 100 may be degraded by Rayleigh scattering. Therefore, it is beneficial that the effective particle diameter of the inorganic fine particles 20 is 100 nm or less in order to achieve high light transmittance in the visible light region. However, when the effective particle diameter of the inorganic fine particles 20 is less than 1 nm, fluorescence may occur if the inorganic fine particles 20 are made of a material that exhibits quantum effects. This fluorescence may affect the properties of an optical component formed of the composite material 100.

From the viewpoints described above, the effective particle diameter of the inorganic fine particles 20 is beneficially in the range from 1 nm to 100 nm, and more beneficially in the range from 1 nm to 50 nm. In particular, it is further beneficial that the effective particle diameter of the inorganic fine particles 20 is 20 nm or less because the negative effect of Rayleigh scattering is very small while the light transmittance of the composite material 100 is particularly high.

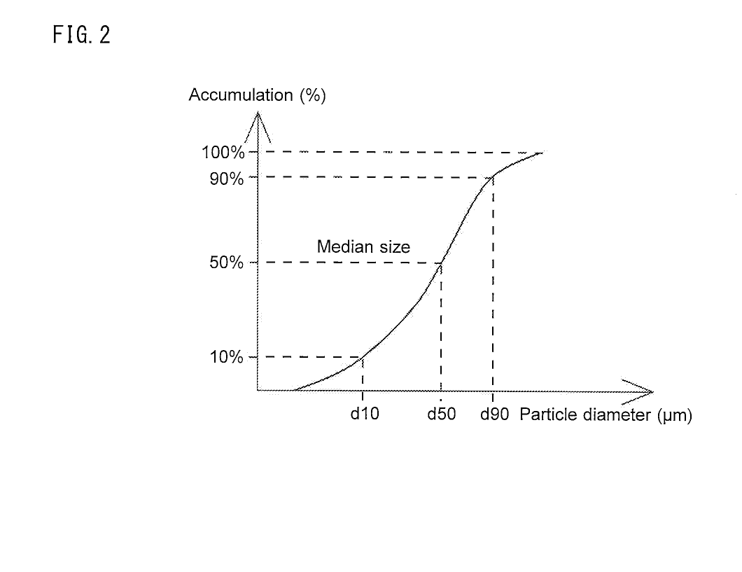

The effective particle diameter of the inorganic fine particles is described with reference to FIG. 2. In FIG. 2, the horizontal axis represents the particle diameters of the inorganic fine particles, and the vertical axis represents accumulation of the inorganic fine particles with respect to the respective particle diameters represented on the horizontal axis. When the inorganic fine particles are aggregated, the particle diameters on the horizontal axis represent the diameters of the secondary particles in an aggregated state. The effective particle diameter refers to the median particle diameter (median size: d50) corresponding to accumulation of 50% in the graph showing the accumulation distribution with respect to the respective particle diameters of the inorganic fine particles as shown in FIG. 2. In order to improve the accuracy of the effective particle diameter, it is beneficial, for example, to take a scanning electron microscope photograph of the inorganic fine particles and measure the particle diameters of at least 200 of the inorganic fine particles.

As described above, the composite material 100 according to Embodiment 1 is obtained by dispersing the inorganic fine particles 20 containing at least gallium phosphate fine particles in the resin material 10. The composite material 100 thus obtained allows free control of its optical constants in a wide range, and has a high refractive index and large positive anomalous dispersion.

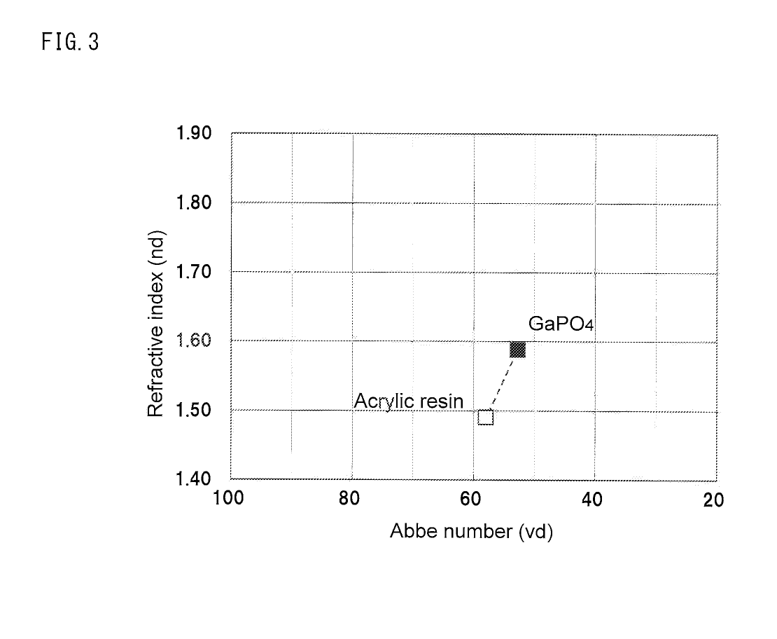

FIG. 3 is a graph showing the relationship between the refractive index nd to the d-line (wavelength of 587.6 nm) and the Abbe number νd to the d-line, which represents the wavelength dispersion property, of each of gallium phosphate and an acrylic resin (a polymer prepared from a photocurable acrylate monomer). The Abbe number νd is a value defined by the following formula (1):

νd=(nd−1)/(nF−nC) (1)

where

nd is the refractive index of the material to the d-line,

nF is the refractive index of the material to the F-line (wavelength of 486.1 nm), and

nC is the refractive index of the material to the C-line (wavelength of 656.3 nm).

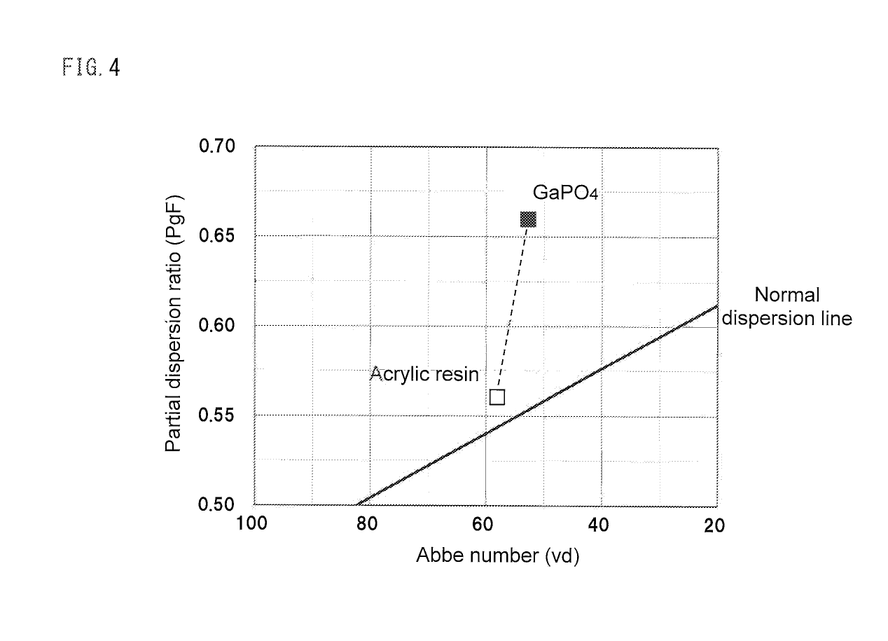

FIG. 4 is a graph showing the relationship between the partial dispersion ratio PgF representing the dispersion properties at the g-line (wavelength of 435.8 nm) and the F-line, and the Abbe number νd representing the wavelength dispersion property, of each of gallium phosphate and the acrylic resin, and a normal dispersion line. The partial dispersion ratio PgF is a value defined by the following formula (2):

PgF=(ng−nF)/(nF−nC) (2)

where

ng is the refractive index of the material to the g-line,

nF is the refractive index of the material to the F-line, and

nC is the refractive index of the material to the C-line.

The anomalous dispersion property ΔPgF is a deviation of the PgF of each material from a point on the reference line of normal partial dispersion glass corresponding to the νd of the material. In the present disclosure, the ΔPgF is calculated using a straight line (normal dispersion line in FIG. 4) passing through the coordinates of glass type C7 (nd of 1.51, νd of 60.5, and PgF of 0.54) and glass type F2 (nd of 1.62, νd of 36.3, and PgF of 0.58) as the reference line of the normal partial dispersion glass, based on the standards of HOYA Corporation.

As shown in FIGS. 3 and 4, gallium phosphate has the following optical properties: refractive index nd of 1.59; Abbe number νd of 52.8; and partial dispersion ratio PgF of 0.66. The anomalous dispersion property ΔPgF of gallium phosphate has a large positive value, that is, 0.11. This value is larger than the anomalous dispersion property ΔPgF, 0.06, of calcium fluoride (CaF₂) known as an anomalous dispersion material. This fact shows that gallium phosphate is a material having very large positive anomalous dispersion.

As described above, the composite material using the inorganic fine particles containing at least gallium phosphate fine particles allows control of the optical properties such as the Abbe number, the refractive index, and the partial dispersion ratio in a wide range. As the result, the composite material is given the properties of high refractive index and very large positive anomalous dispersion. Therefore, the composite material using the inorganic fine particles containing at least gallium phosphate fine particles offers greater flexibility in designing optical components as compared to the conventional materials.

[3. Resin Material]

As the resin material 10, resins having high light transmittance, selected from resins such as thermoplastic resins, thermosetting resins, and energy ray-curable resins, can be used. For example, acrylic resins; methacrylic resins such as polymethyl methacrylate; epoxy resins; polyester resins such as polyethylene terephthalate, polybutylene terephthalate, and polycaprolactone; polystyrene resins such as polystyrene; olefin resins such as polypropylene; polyamide resins such as nylon; polyimide resins such as polyimide and polyether imide; polyvinyl alcohol; butyral resins; vinyl acetate resins; alicyclic polyolefin resins; silicone resins; and amorphous fluororesins may be used. Engineering plastics such as polycarbonate, liquid crystal polymers, polyphenylene ether, polysulfone, polyether sulfone, polyarylate, and amorphous polyolefin also may be used. Mixtures and copolymers of these resins also may be used. Resins obtained by modifying these resins also may be used.

Among these, acrylic resins, methacrylic resins, epoxy resins, polyimide resins, butyral resins, alicyclic polyolefin resins, and polycarbonate are beneficial because these resins have high transparency and good moldability. These resins can have refractive indices nd ranging from 1.4 to 1.7 by selecting a specific molecular skeleton.

The Abbe number νdₘ of the resin material 10 to the d-line is not particularly limited. Needless to say, the Abbe number νd_{COM} of the composite material 100 to the d-line, which is obtained by dispersing the inorganic fine particles 20, increases as the Abbe number νdₘ of the resin material 10 serving as a matrix material increases. In particular, it is beneficial to use a resin having an Abbe number νdₘ of 45 or more as the resin material 10 because the use of such a resin makes it possible to obtain a composite material having optical properties, such as an Abbe number νd_{COM} of 40 or more, enough for use in optical components such as lenses. Examples of the resin having an Abbe number νdₘ of 45 or more include: alicyclic polyolefin resins having an alicyclic hydrocarbon group in the skeleton; silicone resins having a siloxane structure; and amorphous fluororesins having a fluorine atom in the main chain. However, the resin having an Abbe number νdₘ of 45 or more is not limited to these resins.

[4. Optical Properties of Composite Material]

The refractive index of the composite material 100 can be estimated from the refractive indices of the inorganic fine particles 20 and the resin material 10, for example, based on the Maxwell-Garnett theory represented by the following formula (3). It is also possible to estimate the refractive indices of the composite material 100 to the d-line, the F-line, and the C-line from the following formula (3), and further estimate the Abbe number νd of the composite material 100 from the above formula (1). Conversely, the weight ratio between the resin material 10 and the inorganic fine particles 20 may be determined from the estimation based on this theory.

nλ_{COM}²=[{nλₚ²+2nλₘ²+2P(nλₚ²−nλₘ²)}/{nλₚ²+2nλₘ²−P(nλₚ²−nλₘ²)}]×nλₘ² (3)

where

nλ_{COM} is the average refractive index of the composite material 100 at a specific wavelength λ,

nλₚ is the refractive index of the inorganic fine particles 20 at the specific wavelength λ,

nλₘ is the refractive index of the resin material 10 at the specific wavelength λ, and

P is the volume ratio of the inorganic fine particles 20 to the composite material 100 as a whole.

In the case where the inorganic fine particles 20 absorb light or where the inorganic fine particles 20 contain metal, complex refractive indices are used as the refractive indices in the formula (3) for calculation. The formula (3) holds in the case of nλₚ≧nλₘ, and in the case of nλₚ<nλₘ, the refractive index of the composite material 100 is estimated by using the following formula (4):

nλ_{COM}²=[{nλₘ²+2nλₚ²+2(1−P)(nλₘ²−nλₚ²)}/{nλₘ²+2nλₚ²−(1−P)(nλₘ²−nλₚ²)}]×nλₘ² (3)

where nλ_{COM}, nλₚ, nλₘ, and P are the same as those of the formula (3).

The actual refractive index of the composite material 100 can be evaluated by film-forming or molding the prepared composite material 100 into a shape suitable for a measurement method to be used, and actually measuring the formed or molded product by the method. The method is, for example, a spectroscopic measurement method such as an ellipsometric method, an Abeles method, an optical waveguide method or a spectral reflectance method, or a prism-coupler method.

The optical properties of the composite material 100 estimated by using the above-mentioned Maxwell-Garnett theory is described. An exemplary case is described in which gallium phosphate fine particles are used as the inorganic fine particles 20 and an acrylic resin (a polymer prepared from a photocurable acrylate monomer) is used as the resin material 10.

As described above, each of FIGS. 3 and 4 is a graph plotting the optical properties of gallium phosphate and the acrylic resin. Further, in each of FIGS. 3 and 4, a dashed line connecting these two plots is shown. The composite material 100 can exhibit the optical properties indicated on the dashed lines shown in FIGS. 3 and 4 by adjusting the proportions of gallium phosphate and the acrylic resin contained in the composite material 100. When the composite material 100 contains a high proportion of gallium phosphate, the values of the optical properties of the composite material 100 are close to those of gallium phosphate. When the composite material 100 contains a high proportion of the acrylic resin, the values of the optical properties of the composite material 100 are close to those of the acrylic resin. That is, the composite material 100 having desired optical properties can be formed by adjusting the proportions of gallium phosphate and the acrylic resin.

In practice, when the content of the inorganic fine particles 20 in the composite material 100 is too small, the effect of adjustment for the optical properties due to the inorganic fine particles 20 may not be sufficiently obtained. Therefore, the content of the inorganic fine particles 20 is beneficially 1% by weight or more, more beneficially 5% by weight or more, and further beneficially 10% by weight or more, with respect to the total weight of the composite material (optical material) 100. On the other hand, when the content of the inorganic fine particles 20 in the composite material 100 is too large, the fluidity of the composite material 100 decreases, which may make it difficult to give an optical element by molding the composite material 100 or even to add the inorganic fine particles 20 into the resin material 10. Thus, the content of the inorganic fine particles 20 is beneficially 80% by weight or less, more beneficially 60% by weight or less, and further beneficially 40% by weight or less, with respect to the total weight of the composite material (optical material) 100.

[5. Production Method of Composite Material]

First, a method for forming the inorganic fine particles 20 is described. The inorganic fine particles 20 can be formed by a liquid phase method, such as a coprecipitation method, a sol-gel method, or a metal complex decomposition method, or by a vapor phase method. Alternatively, a bulk may be ground into fine particles by a grinding method using a ball mill or a bead mill to form the inorganic fine particles 20. It is noted that gallium phosphate to be contained in the inorganic fine particles 20 can be obtained by a hydrothermal reaction of gallium nitrate (III) hydrate and phosphoric acid.

Next, a method for preparing the composite material 100 is described. There is no particular limitation on the method for preparing the composite material 100 by dispersing the inorganic fine particles 20 formed by the above-described method in the resin material 10 serving as a matrix material. The composite material 100 may be prepared by a physical method or by a chemical method. For example, the composite material 100 can be prepared by any of the following Methods (1) to (4).

Method (1): A resin or a solution in which a resin is dissolved is mechanically and/or physically mixed with inorganic fine particles.

Method (2): A monomer, an oligomer, or the like as a raw material of a resin is mechanically and/or physically mixed with inorganic fine particles to obtain a mixture, and then the monomer, the oligomer, or the like as a raw material of a resin is polymerized.

Method (3): A resin or a solution in which a resin is dissolved is mixed with a raw material of inorganic fine particles, and then the raw material of the inorganic fine particles is reacted so as to form the inorganic fine particles in the resin.

Method (4): After a monomer, an oligomer, or the like as a raw material of a resin is mixed with a raw material of inorganic fine particles, a step of reacting the raw material of inorganic fine particles so as to form the inorganic fine particles and a step of polymerizing the monomer, the oligomer, or the like as a raw material of a resin so as to synthesize the resin are performed.

The above methods (1) and (2) are advantageous in that various pre-formed inorganic fine particles can be used and that composite materials can be prepared by a general-purpose dispersing machine. On the other hand, the above methods (3) and (4) require chemical reactions, and therefore, usable materials are limited to some extent. However, since the raw materials are mixed at the molecular level in the methods (3) and (4), these methods are advantageous in that the dispersion property of the inorganic fine particles can be enhanced.

In the above methods, there is no particular limitation on the order of mixing the inorganic fine particles or the raw material of the inorganic fine particles with a resin, or a monomer, an oligomer, or the like as the raw material of the resin. A desirable order can be selected as appropriate. For example, the resin or the raw material of the resin or a solution in which the resin or the raw material of the resin is dissolved may be added to a solution in which inorganic fine particles having a primary particle diameter substantially in the range from 1 nm to 100 nm are dispersed to mix them mechanically and/or physically. The production method of the composite material 100 is not particularly limited as long as the effect of the present disclosure can be achieved.

The composite material 100 may contain components other than the inorganic fine particles 20 and the resin material 10 serving as a matrix material, as long as the effect of the present disclosure can be achieved. For example, a dispersant or a surfactant that improves the dispersion property of the inorganic fine particles 20 in the resin material 10, or a dye or a pigment that absorbs electromagnetic waves within a specific range of wavelengths may coexist in the composite material 100, although not shown in the drawings.

### Embodiment 2

Hereinafter, Embodiment 2 is described with reference to the drawings. Embodiment 2 relates to an optical element formed by using the composite material 100 according to Embodiment 1.

The optical element is, for example, a lens, a prism, an optical filter, or a diffractive optical element. Among these, the optical element is beneficially a lens or a diffractive optical element. Hereinafter, the case where the optical element according to Embodiment 2 is a lens is described specifically.

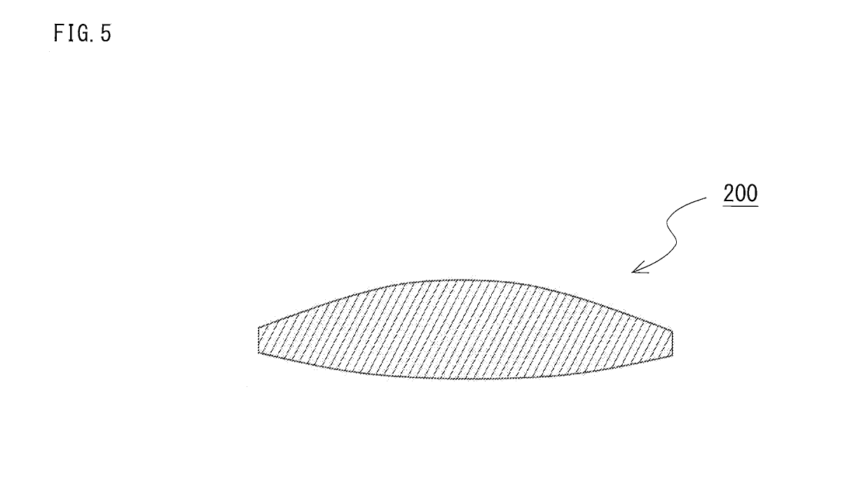

An example of the optical element according to Embodiment 2 is a lens 200 shown in a schematic structural diagram of FIG. 5. The lens 200 shown in FIG. 5 can be produced by using the composite material 100 according to Embodiment 1 in accordance with known techniques. For example, the lens 200 can be produced by molding the composite material 100 in accordance with a known technique, or polishing a bulk of the composite material 100, or putting the raw material of the resin material 10 (a monomer, an oligomer, or the like) mixed with the inorganic fine particles 20 into a mold so as to polymerize the raw material therein.

The both surfaces of the lens 200 shown in FIG. 5 are convex, but at least one of the surfaces may be concave. There is no particular limitation on the shape of the lens 200. The lens 200 is designed as appropriate for the desired optical properties.

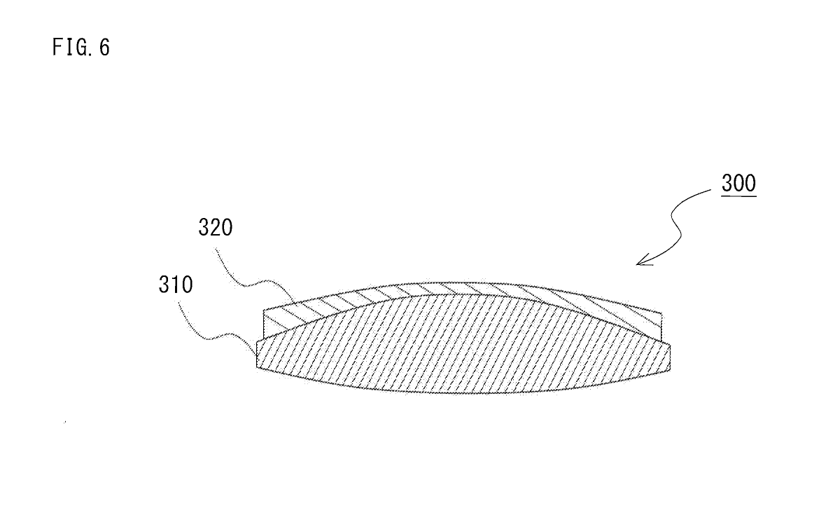

Another example of the optical element according to Embodiment 2 is a hybrid lens 300 shown in a schematic structural diagram of FIG. 6. The hybrid lens 300 is composed of a first lens 310 serving as a base, and a second lens 320 disposed on an optical surface of the first lens 310. The hybrid lens 300 is an example of a hybrid optical element among optical elements.

The first lens 310 is a first optical element, and an example of a glass lens. The first lens 310 is formed of a glass material, and is a bi-convex lens.

The second lens 320 is a second optical element, and an example of a resin lens. The second lens 320 is formed of a composite material, and the composite material 100 according to Embodiment 1 is used as the composite material.

The both surfaces of the hybrid lens 300 shown in FIG. 6 are convex, but at least one of the surfaces may be concave. There is no particular limitation on the shape of the hybrid lens 300. The hybrid lens 300 is designed as appropriate for the desired optical properties. In the hybrid lens 300 shown in FIG. 6, the second lens 320 is disposed on one of optical surfaces of the first lens 310, but the second lens 320 may be disposed on both the optical surfaces of the first lens 310.

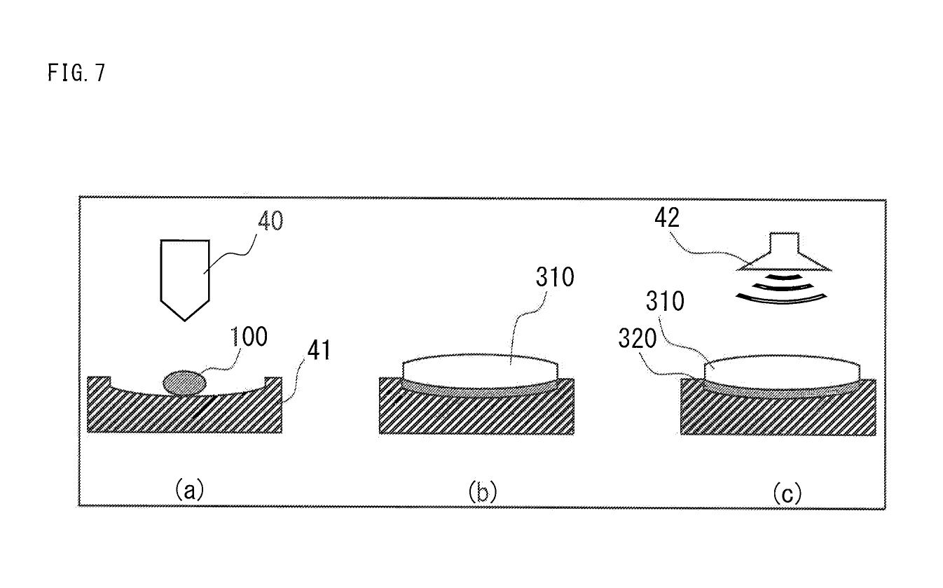

There is no particular limitation on the method for producing the hybrid lens 300, and the hybrid lens 300 may be produced by known techniques. For example, a method shown in FIG. 7 and described below may be adopted. The resin material 10 included in the composite material 100 is an acrylic resin (a polymer prepared from a photocurable acrylate monomer).

FIG. 7 is a schematic diagram explaining an example of a production process of the hybrid lens 300 according to Embodiment 2. First, the first lens 310 is molded. There is no particular limitation on the first lens 310 as an example of a glass lens, and the first lens 310 may be molded by using a known production method such as lens polishing, injection molding, or press molding.

As shown in FIG. 7(a), the composite material 100 is discharged onto a mold surface of a mold 41 by using a dispenser 40.

Next, as shown in FIG. 7(b), the first lens 310 is placed onto the composite material 100 so that the composite material 100 is pressed and extended to a predetermined thickness.

Then, as shown in FIG. 7(c), an ultraviolet ray is radiated toward the top of the first lens 310 from a light source 42 to cure the composite material 100, thereby obtaining the hybrid lens 300 as a hybrid optical element in which the second lens 320 is disposed on an optical surface of the first lens 310.

As described above, Embodiments 1 to 2 have been described as examples of art disclosed in the present application. However, the art in the present disclosure is not limited to these embodiments. It is understood that various modifications, replacements, additions, omissions, and the like have been performed in these embodiments to give optional embodiments, and the art in the present disclosure can be applied to the optional embodiments.

Hereinafter, the present disclosure is described in detail with reference to examples and comparative examples. However, the present disclosure is not limited to these examples.

### Example 1

Gallium nitrate n-hydrate was dissolved in pure water to prepare an aqueous gallium nitrate solution having a concentration of 0.05 M. To the aqueous solution, 21 parts by weight of phosphoric acid per 100 parts by weight of pure water was added. To the resulting mixture, 30 moles of hexanoic acid per 1 mole of gallium nitrate was added. The mixture thus prepared was placed in a reactor, and heated to 300° C. with stirring and allowed to react for 10 minutes. Then, the mixture was rapidly cooled to stop the reaction. The pressure reached to about 30 MPa during the heating.

Then, fine particles were precipitated from the resulting liquid solution by centrifugation. The fine particles were washed with ethanol and dried. The resulting fine particles were calcined at 350° C. for 60 minutes in a calcining furnace to obtain gallium phosphate fine particles having crystallinity due to GaPO₄. The maximum particle diameter, the minimum particle diameter, and the effective particle diameter of the gallium phosphate fine particles, which were obtained by taking scanning electron microscope (SEM) photographs, were 100 nm, 25 nm, and 55 nm, respectively.

In ethyl acetate serving as a solvent, a dispersant (trade name “DISPERBYK-2155”, manufactured by BYK Japan KK) and the gallium phosphate fine particles were mixed in a weight ratio of 3:1 to disperse the gallium phosphate fine particles in the solvent, and thus an ethyl acetate slurry containing the gallium phosphate fine particles was obtained.

The ethyl acetate slurry containing the gallium phosphate fine particles thus obtained was mixed with a photocurable acrylate monomer (trade name “M-8060”, manufactured by Toagosei Co., Ltd.) and a polymerization initiator (trade name “Irgacure 754”, manufactured by BASF SE), and the solvent was removed from the mixture under vacuum. The resulting mixture was cured with ultraviolet radiation. Thus, a composite material was obtained. The content of the gallium phosphate fine particles in the composite material was 8.0% by weight.

### Comparative Example 1

A mixture of a photocurable acrylate monomer and a polymerization initiator, which were the same as those used in Example 1, was cured with ultraviolet radiation, and the resulting cured material was used as a material for Comparative Example 1.

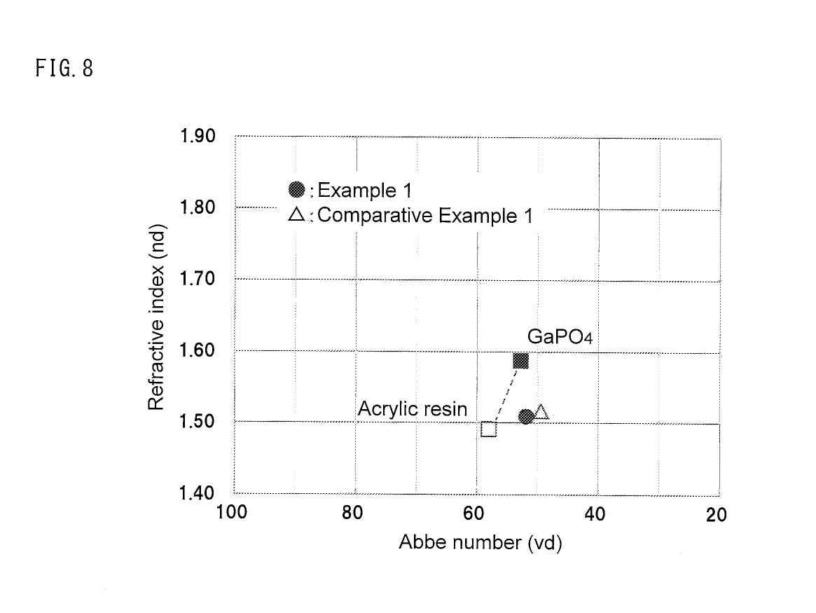

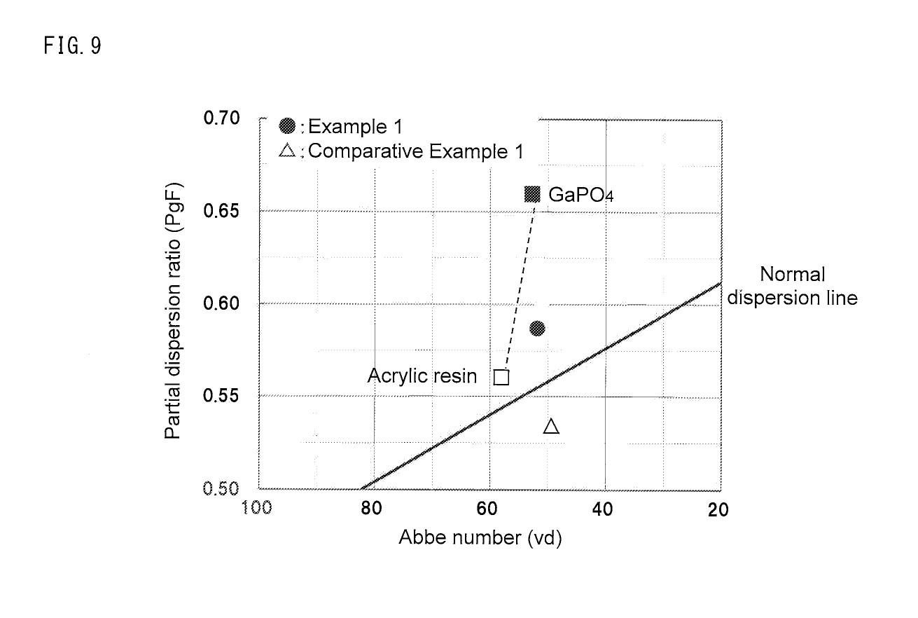

The refractive indices (ng, nF, nd, and nC) to the g-line, the F-line, the d-line, and the C-line of the materials of Example 1 and Comparative Example 1 were measured by using a prism coupler refractometer (manufactured by Metricon Corporation). The Abbe numbers νd were calculated from the formula (1), and the partial dispersion ratios PgF were calculated from the formula (2). Further, the anomalous dispersion properties ΔPgF were obtained from the calculated PgF. Table 1 and FIGS. 8 and 9 show the results.

TABLE 1

| | Refractive index | | | | | | |
|---|---|---|---|---|---|---|---|
| | ng | nF | nd | nC | vd | PgF | ΔPgF |
| Ex. 1 | 1.52154 | 1.51578 | 1.50881 | 1.50596 | 51.80 | 0.587 | 0.03 |
| Com. Ex. 1 | 1.52970 | 1.52411 | 1.51671 | 1.51365 | 49.40 | 0.534 | −0.03 |

The results shown in Table 1 and FIGS. 8 and 9 reveal that the composite material of Example 1, whose optical properties are affected by the optical properties of gallium phosphate, exhibit higher Abbe number and larger positive anomalous dispersion as compared to the material of Comparative Example 1 containing only the resin material. Therefore, it is found that the use of the gallium phosphate fine particles as the inorganic fine particles makes it possible to obtain an optical material having the optical properties of low dispersion and large positive anomalous dispersion.

The present disclosure can be suitably used for optical elements such as a lens, a prism, an optical filter, and a diffractive optical element.

As described above, embodiments have been described as examples of art in the present disclosure. Thus, the attached drawings and detailed description have been provided.

Therefore, in order to illustrate the art, not only essential elements for solving the problems but also elements that are not necessary for solving the problems may be included in elements appearing in the attached drawings or in the detailed description. Therefore, such unnecessary elements should not be immediately determined as necessary elements because of their presence in the attached drawings or in the detailed description.

Further, since the embodiments described above are merely examples of the art in the present disclosure, it is understood that various modifications, replacements, additions, omissions, and the like can be performed in the scope of the claims or in an equivalent scope thereof.

What is claimed is:

1. An optical material comprising a resin material and inorganic fine particles dispersed in the resin material, the inorganic fine particles containing at least gallium phosphate fine particles.

2. An optical element formed of the optical material as claimed in claim 1.

3. A hybrid optical element comprising a first optical element and a second optical element disposed on an optical surface of the first optical element, the second optical element being the optical element as claimed in claim 2.
